(19) United States
(12) Patent Application Publication
(10) Pub. No.: US 2014/0052562 A1
(43) Pub. Date: Feb. 20, 2014

(54) SYSTEM AND METHOD FOR INTERACTIVE AND SOCIAL SHOPPING

(71) Applicants: Eduardo P. Oliveira, Seattle, WA (US); Bryan K. Ressler, Sammamish, WA (US); Aamer Hydrie, Seattle, WA (US); Kamal Jain, Bellevue, WA (US); Oren Hod, Sunnyvale, CA (US)

(72) Inventors: Eduardo P. Oliveira, Seattle, WA (US); Bryan K. Ressler, Sammamish, WA (US); Aamer Hydrie, Seattle, WA (US); Kamal Jain, Bellevue, WA (US); Oren Hod, Sunnyvale, CA (US)

(73) Assignee: eBay Inc., San Jose, CA (US)

(21) Appl. No.: 13/681,187

(22) Filed: Nov. 19, 2012

Related U.S. Application Data
(60) Provisional application No. 61/684,407, filed on Aug. 17, 2012.

(51) Int. Cl. G06Q 30/06

(52) U.S. Cl. CPC G06Q 30/0643; G06Q 30/0621
USPC 705/26.5; 705/27.2

(57) ABSTRACT

Disclosed in some examples is a method of providing assistance to a consumer comprising authenticating with a shopping service over a network using a network adapter; downloading a shopping list from the shopping service over the network using a network adapter; displaying the shopping list to the user on a display screen, the shopping list comprising a name of an item, wherein each item in the shopping list may be displayed as a tile, wherein each tile is arranged in a series of rows and columns; receiving an input identifying one or more changes to the shopping list; processing the input using a computer processor; and sending the one or more changes to the shopping service over the network using the network adapter.

### CLAIM OF PRIORITY

This patent application claims the benefit of priority, under 35 U.S.C. Section 119(e), to U.S. Provisional Patent Application Ser. No. 61/684,407, entitled “System and Method for Interactive and Social Shopping,” filed on Aug. 17, 2012, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc., All Rights Reserved.

### BACKGROUND

While technology has opened up new forms of commerce and provided customers with additional shopping options, it has not radically altered traditional shopping at traditional brick and mortar shops.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example graphical user interface of an example shopping application according to some examples of the present disclosure.

FIG. 2 is an example graphical user interface of an example bar code reader according to some examples of the present disclosure.

FIG. 3 is an example graphical user interface of an example shopping application according to some examples of the present disclosure.

FIG. 4 is an example graphical user interface of an example shopping application according to some examples of the present disclosure.

FIG. 5 is an example graphical user interface of an example shopping application according to some examples of the present disclosure.

FIG. 6 is an example graphical user interface of an example shopping application according to some examples of the present disclosure.

FIG. 7 is an example graphical user interface of an example shopping application according to some examples of the present disclosure.

FIG. 8 is an example graphical user interface of an example shopping application according to some examples of the present disclosure.

FIG. 9 is an example graphical user interface of an example shopping application according to some examples of the present disclosure.

FIG. 10 is a schematic of an example shopping system according to some examples of the present disclosure.

FIG. 11 is an example graphical user interface of an example shopping application according to some examples of the present disclosure.

FIG. 12 is a flowchart of an example method according to some examples of the present disclosure.

FIG. 13 is a flowchart of an example method according to some examples of the present disclosure.

FIG. 14A is a logical block diagram of an example application interface.

FIG. 14B is a logical block diagram of a shopping service.

FIG. 14C is a schematic of a mobile computing device according to some examples of the present disclosure.

FIG. 15 is a schematic of a machine according to some examples of the present disclosure.

### DETAILED DESCRIPTION

Disclosed in some examples are methods, systems, and machine readable media which assist consumers in shopping for various items in physical stores. Various web and application interfaces may communicate with a shopping service over a network to facilitate the creation, editing, and viewing of a shopping list. The shopping list may assist the consumer by providing a graphical indication of items the consumer wishes to purchase and by showing an indication that the item was purchased or put in the consumer's shopping cart to purchase.

Creation, editing, and viewing of the shopping list may be done on a dedicated application executable on a computing device (such as a mobile computing device), or through a web interface on any computing device capable of supporting a web-interface. The shopping list may be created, viewed, and edited simultaneously in multiple locations. For example, the consumer's roommate may login to the shopping service using a web interface from a computing device as the consumer is shopping and viewing the list on their mobile device. Any changes to the list made by the roommate may show up automatically on the mobile device so that the consumer can see them.

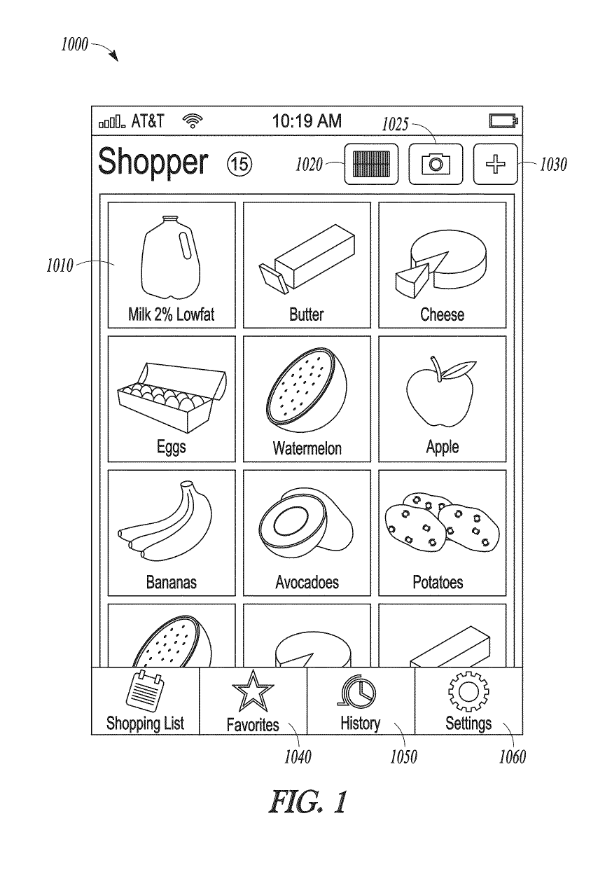

Turning now to FIG. 1, an example screen 1000 of a dedicated application is shown. A shopping list is laid out as a series of horizontally and vertically arranged tiles (e.g., the 1010 which shows milk) with item images and descriptions. In some examples, the descriptions may be generic (e.g., “Milk”), but in other examples, it may be specific (e.g., “Golden Guernsey™ Milk”). Users can scroll up and down to see additional items in the list. While the example of FIG. 1 shows the list as a series of horizontal and vertically arranged tiles, the items in the list may be represented in any number of ways. For example, the items may be represented in any one of, or any combination of, a horizontal list, a vertical list, with a graphic, without a graphic, or the like.

In some examples, each item may have a series of properties. For example, each item may have a category property which describes a type of item. Thus milk would be in the dairy category. In some examples, the shopping list may be sorted based on category. Shown in FIG. 1, the dairy items are grouped together. This may facilitate faster shopping as consumers can pick up everything they need in the same store department at once, rather than having to backtrack for an item later in the list.

In other examples, the shopping system may order the tiles more precisely by store layout. For example, the consumer may inform the system about which store the consumer is shopping in, and the system may re-order the list so as to create the most efficient path for the consumer through the store. The shopping system may have a store layout database which may inform the shopping system about the layout of particular stores. Based upon the store layout and the items in the consumer's list, the shopping system may plan the optimal route through the store which minimizes time, distance, or both. In some examples, the consumer may add or edit a store layout if the shopping system does not have the layout for their particular store. In other examples, the consumer may set up the system such that the system orders the shopping list according to a preferred walking route through the store (the preferred route may not be the most efficient route, but may be desirable for the consumer for other reasons, e.g., perhaps the consumer likes to shop for meats before dairy, or perhaps wants to shop for foods requiring refrigeration last to avoid spoilage).

In yet other examples, the shopping system may order items based upon the order in which the consumer checked off particular items in the past. For example, if the consumer usually buys milk before bread, then the shopping system may order the milk before the bread. In some examples, the system may infer the layout of the store based upon the order in which items are checked off in the past. This analysis may be limited to individual users, but in other examples, the system may infer the layout of a particular store based on an aggregate of all or a large subset of users of the system. In some examples, the system may infer the layout of one store based on the order that items are checked off at similar stores. For example, chain stores often have similar store layouts and thus the order in which items are checked off at one store in a chain may be used to infer the layout of another store in the same chain of stores.

While the example screen shown in FIG. 1 does not show prices, in some examples, a user may select one or more different stores for each product or each list. The store's price for that product may be displayed. The displayed product's price may factor in delivery where applicable. In yet other examples, the shopping system may show the consumer several prices for several different local and online stores so the consumer may compare prices for a particular item.

In yet other examples, the shopping system may show quantity. The shopping system may link with a merchant's inventory system and deliver to the consumer how many items in a consumer's list the merchant has in stock.

The application may allow consumers to add and delete items from their shopping list from one of the shopping interfaces (i.e., a dedicated application or a web interface). To add items to the shopping list, the consumer may search for the item in a stock collection of items (either stored in the application itself or on the shopping service) based on a textual search, a scan of the item's bar code, a picture of the item, or the consumer may add their own items.

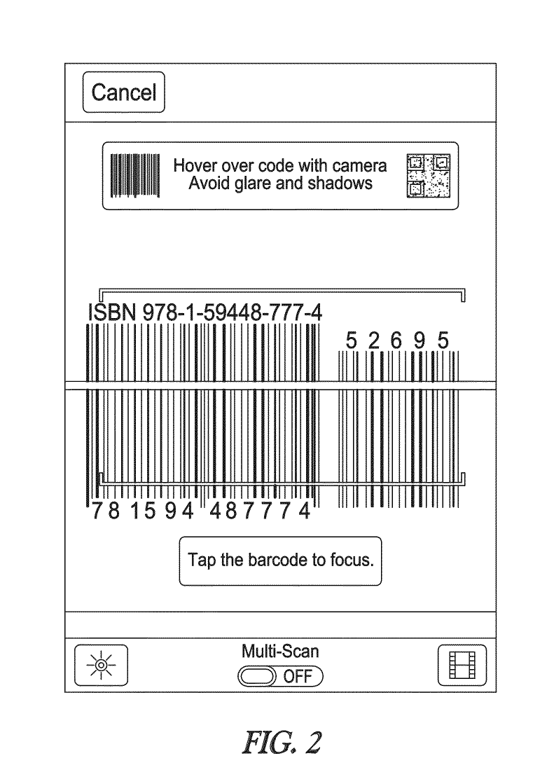

In the example screen of FIG. 1, bar code button 1020 brings up the bar code reader application or module which will read a bar code. FIG. 2 shows an example screen 2000 showing the bar code reader application or module. The product identification number scanned from the bar code may be used to search the item collection in the shopping system. Matching items may be added to the shopping list. If the shopping system does not have a record for that particular item, the shopping system may search the internet for information on the item, or present the consumer with a form where the consumer may enter the item details (and add the item to the item collection).

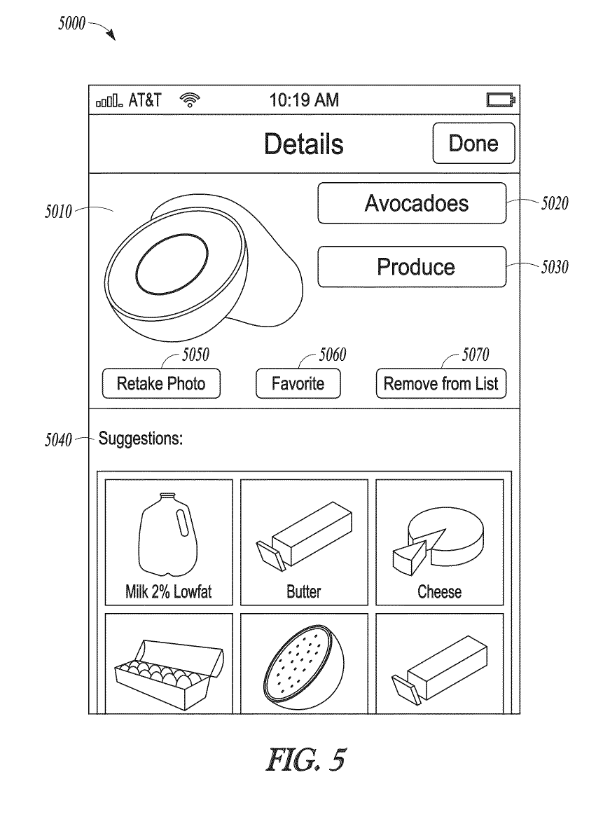

Camera button 1025 may allow users to add an item to the shopping list based upon taking a picture of the item. The shopping system may utilize image recognition to determine the properties of the product automatically based on matching the photo taken of the product to photos of products in the item collection of the shopping system. In other examples, the system may take the user to the item properties screen shown in FIG. 5 (described later) where the consumer may enter details about the product and that product may then be added to the item collection.

The add new item button 1030 of FIG. 1, brings up a text entry field for adding items to the consumer's list by textual search. Consumers may search for items to add to the shopping list by entering a generic item name (e.g., “milk”) or by entering a specific brand of item (e.g., “Golden Gurnsey™ milk”), or in some examples, the consumer may first search for items by a generic name and then once the generic name is selected, a specific list of particular brands and/or sizes may be selected. Selected items may be placed on the consumer's shopping list. In some examples, as the consumer type a product or brand name into a text entry field, and as the text is entered, the application may suggest items, and in some examples, specific brands. The suggested items may be ordered based upon one or more of: their relevance to the typed text, whether or not the item is a consumer's favorite item (as previously designated by the consumer), whether or not the consumer has previously purchased the item, whether or not the item was recently purchased by one or more members in the consumer's social circle, whether or not the item is a favorite item of one or more members in the consumer's social circle, or the like. Items marked as favorite items may be displayed on a “favorites” page with an easy button click to add it to the current shopping list.

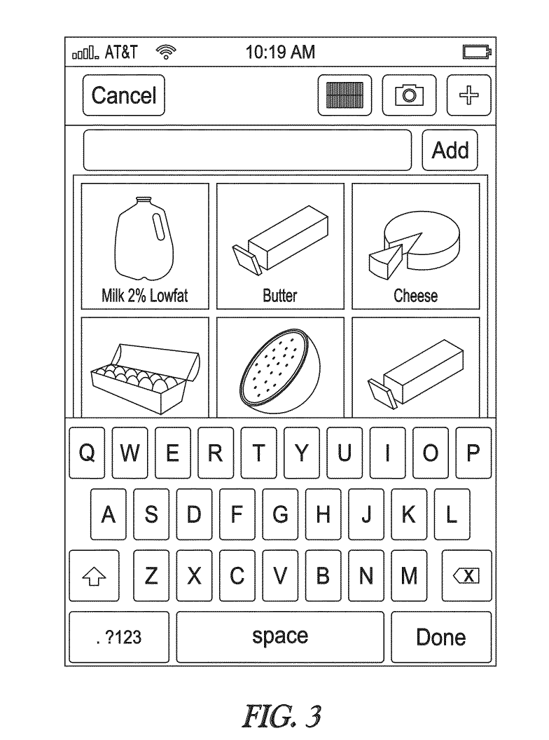

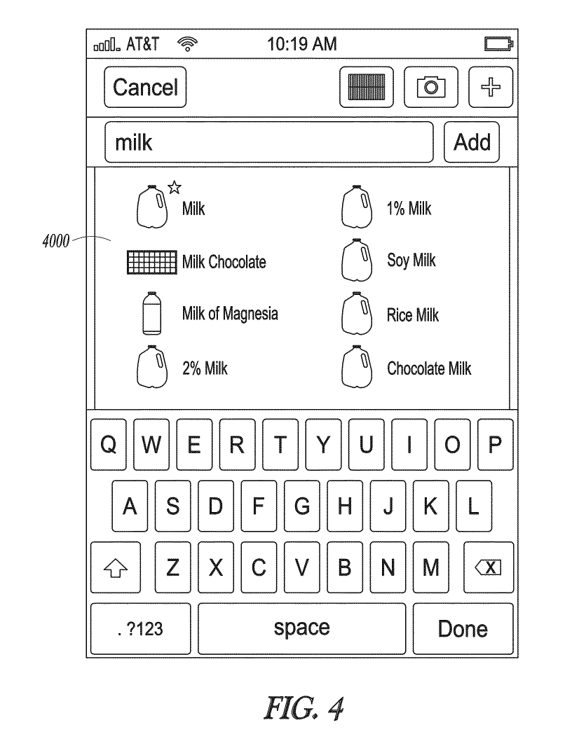

FIG. 3. shows an add item entry field with keypad. FIG. 4 shows the shopping system's suggested items in a drop down menu 4000 based on the text as it is entered. The consumer in FIG. 4 has typed “milk” and the system suggests “Milk,” “Milk Chocolate,” “Milk of Magnesia,” “2% Milk,” “1% Milk,” “Soy Milk,” “Rice Milk,” and “Chocolate Milk.” In some examples, the ordering of these items may be based upon a predicted best match, but in other examples, matching favorites may be given priority in the listing, followed by matching items that were previously purchased items. A consumer may select one of the suggestions by tapping, clicking or otherwise selecting the item in the drop down list. If there is no match for the item in the text entry field, a new item may be created (the consumer would type in the name of the item and press the “add” button) and the consumer will be asked to enter details about the item on a newly created details page. FIG. 5 describes the details page. Once the details are entered, the system may store the item in the item collection either locally (just for that user), a group of users (perhaps a group of friends who all utilize the system and have associated themselves voluntarily with each other), or globally (all users of the shopping system).

By double clicking on, double tapping on, or otherwise interacting with, one of the item tiles in the list, or by adding a new item, the item details page may be shown. Turning now to FIG. 5, an item details page 5000 is shown. The item's picture 5010 along with its name 5020 and its category 5030 are also shown. Tapping or selecting the name 5020 or the category 5030 allows a consumer to edit the name or category. Selecting the “Retake Photo” option 5050 allows the consumer to change (or take) the photo of the product. Favorite button 5060 may allow the consumer to add the item to their list of favorites. Remove from list button 5070 may remove the item from the consumer's current shopping list. Other details may also be stored, such as the item's bar code, quantity of the item, notes about the item, and the like.

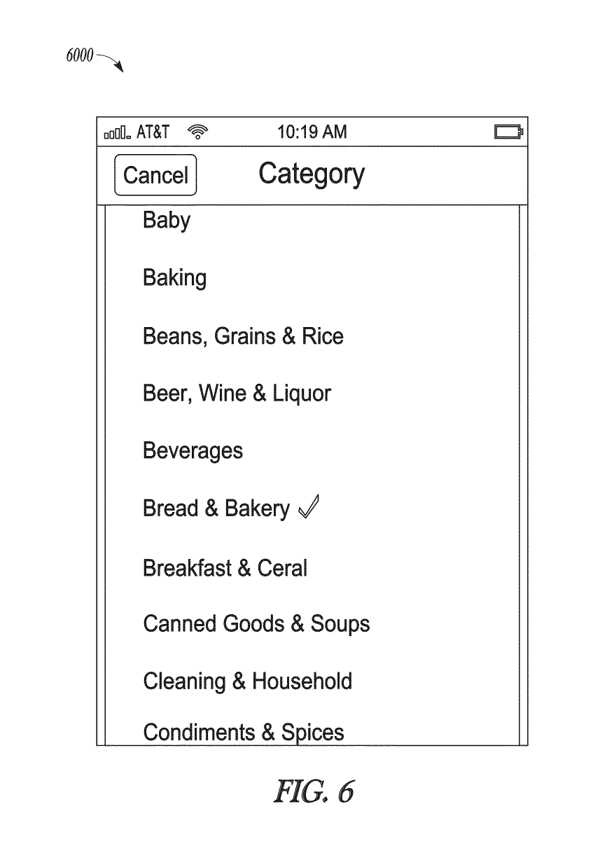

Changing the category using button 5030 may pull up a category selection screen 6000 shown in FIG. 6. In some examples, the category may be a simple listing, but in other examples, the category selection may be a collapsible tree with subcategories.

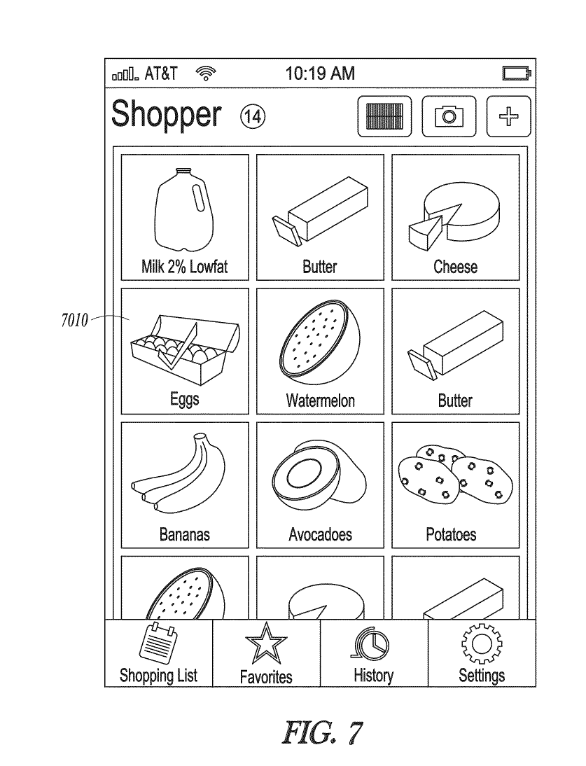

Turning now to FIG. 7, an example tile transition 7010 is shown. The tile 7010 was tapped, touched, clicked, or selected by the consumer, indicating that the item was put into the shopping cart or purchased. In response, the system may graphically indicate that the item was put into the shopping cart or purchased. In some examples, this may include an animation. For example, the tile may turn over, revealing the mirror image, may be shaded darker, or marked with a checkmark. Inadvertently checked items may be unchecked. In some examples, in addition to the tile graphically indicating that the item was put into the shopping cart and/or purchased, the tile may be moved to the back of the list, such that tiles representing items that have not yet been purchased or placed into the cart may appear first.

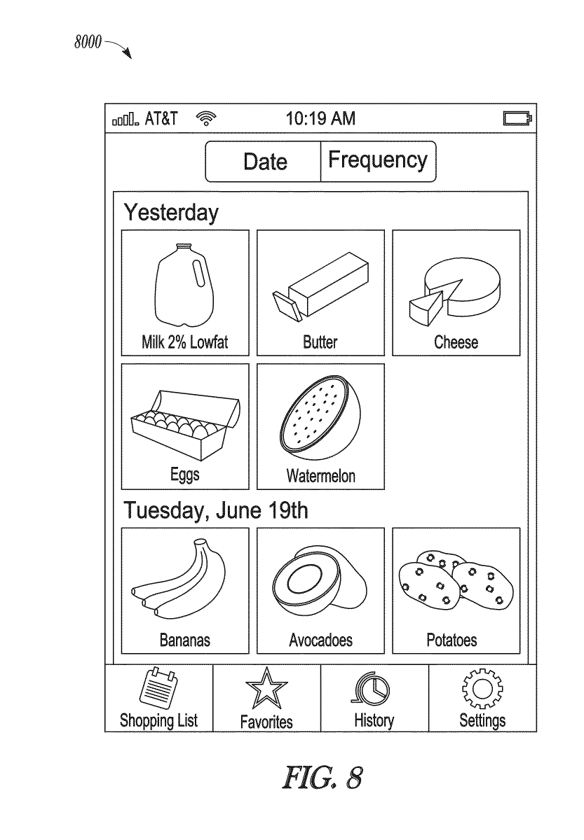

Turning back to FIG. 1, a consumer may select to view a list of items marked as favorites by selecting option 1040. The consumer may also see a list of past items purchased by selecting the history option 1050. FIG. 8 shows an example screen 8000 of past purchase history. Past purchases may be grouped by date purchased, item type, quantity, category, or the like. As already explained, this purchase history may be used to suggest items as consumers enter text into the text entry field. In other examples, the purchase history may be used by consumers to monitor their consumption patterns (e.g., to monitor eating habits). In yet other examples, the system may use the purchase history to automatically remind consumers that they may need to replenish a particular item. For example, if the system notices that a user purchases milk every two weeks, the system may remind the user near the two week mark since the last time milk was purchased that the consumer should purchase milk.

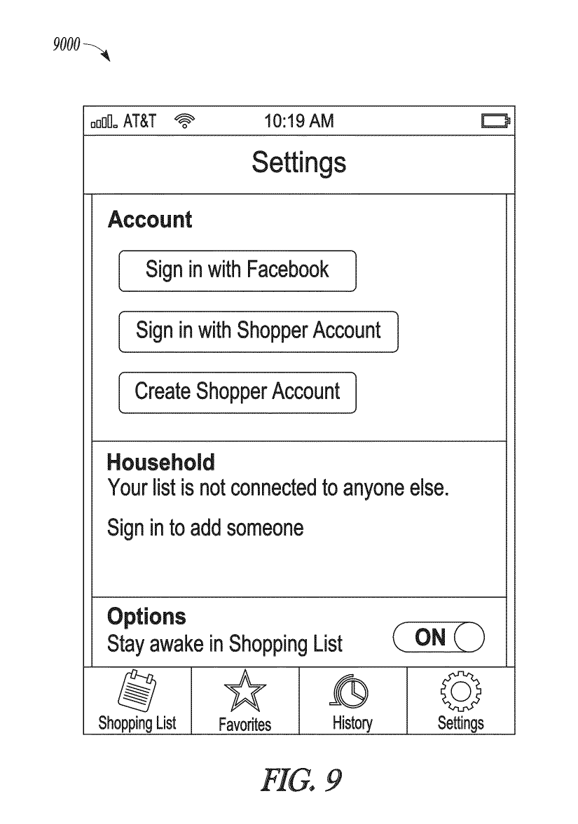

Turning back to FIG. 1, by activating the settings feature 1060, a user may modify one or more of the application preferences. For example, FIG. 9 shows an example setting screen 9000. Users may sign into a central shopping system using a social networking account, an account on the shopping service, or they can create an account on the shopping service through the application. In other examples, the user's shopping service account may be linked to another user's account. In some examples, lists stored in the other user's account may appear in the user's application. This may allow for collaborative, social shopping. For example, two roommates may share lists so as to allow for one roommate to do the shopping for both, thus sharing a trip.

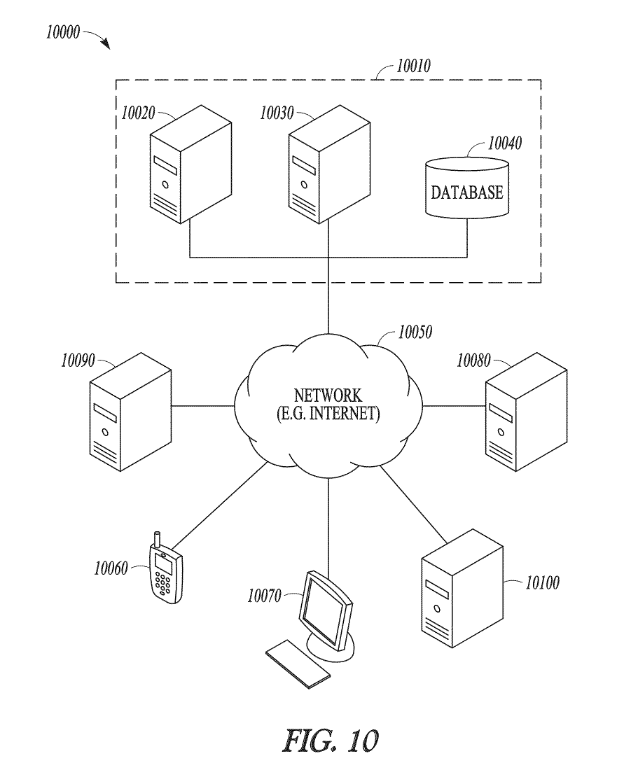

Turning now to FIG. 10, an example shopping system 10000 is shown. Shopping service 10010 may comprise one or more computer servers 10020, 10030 and one or more databases 10040. Databases 10040 may store user information such as name, address, phone number, username, password, or the like. Databases 10040 may also store one or more shopping lists for each user. Each shopping list may contain one or more items. Databases 10040 may store a default item collection or database which may store information about various items (including pictures, categorization, and information about those items) from which users may choose to add to their lists. A user may customize an item, or add their own. These updates or additions may be stored per individual user, or may modify the global default item database.

Service 10010 may provide one or more web-based, or other interfaces (e.g., through a dedicated application) across network 10050 to mobile devices (such as mobile device 10060) and other computing devices (such as computing device 10070). This interface may allow users to create lists, view lists, modify lists, delete lists, add items, view items, modify items, delete items, modify favorites, view favorites, view past purchase history, change account settings, or the like.

Network 10050 may be or include a Wide Area Network (WAN), a Local Area Network (LAN), a Cellular Network (such as a Long Term Evolution network), or the like. Network 10050 may be any network which may allow mobile computing device 10060 and computing device 10070 to communicate with the shopping service 10010.

Mobile computing device 10060 and/or computing device 10070 may access shopping service 10010 either through the web-based interface (e.g., through the use of a web browser which may access one or more web pages provided by the shopping service 10010) or may access the shopping service 10010 through an application executing on mobile computing device 10060 or an application executing on the computing device 10070.

In some examples, the application or web interface may communicate with the shopping service 10010 to retrieve shopping lists, information on items, past purchase history, favorite lists, or the like. The user may then update these items and save these changes back to the shopping service 10010. In some examples, one user may be making changes to the list, items, or the like while another user is viewing or modifying these items. In some examples, shopping service 10010 may push changes made by one user to other users who are currently viewing or editing information for that same account. Thus a user who is shopping may see his spouse's additions to the shopping list in near real time.

Other services, such as special offers and promotions service 10080 may provide users special offers or promotions based on their purchase histories. In some examples special offers and promotions service 10080 may communicate these offers to the shopping service 10010 where it may be added to the user's information stored in the database 10040 and later communicated to the user. In other examples, the special offers and promotions service 10080 may communicate these special offers and promotions to the user's mobile computing device 10060 or other computing device 10070. As shown in FIG. 10, special offers and promotions service 10080 is a separate service from shopping service 10010, but in other examples, special offers and promotions service 10080 may be part of shopping service 10010.

Store and product information service 10090 may contain a list of stores, their layouts, their products, the prices of those products, and/or the in stock quantities of those products. While store and product information service 10090 is shown as a separate service from shopping service 10010, in other examples, store and product information service 10090 may be part of shopping service 10010. In some examples, the shopping service 10010 may use the store and product information provided by store and product information service 10090 to sort the item lists. For example, the system may sort the list so that the user may complete their shopping in the fastest possible time. In other examples, the system may sort their shopping list such that the consumer is routed past an area of the store which contains a sponsored product. For example, if the user has dairy items, produce items, and baked goods items, the user may be routed in such a way as to pass the meat department which may contain a sponsored brand of sausage. In yet other examples, the list may also be ordered based upon an ordering which maximizes the consumer's opportunity to see promotional items of potential interest at a store. This might be attractive as some shoppers like to see deals at a store. In still other examples, the list may be ordered based upon an ordering which maximizes the consumer's opportunity to see high margin items of potential interest at a store. Store owners may wish to have the list ordered this way so as to generate traffic past high margin items. In yet other examples, the system may order items to see both high margin and promotional items. As with the sponsored products, the system may do this by rearranging the order of the items in the list based on the store layout in order to take the user by certain areas of the store so the consumer may traverse areas of the store with promotional or high margin items regardless of whether or not they are on the consumer's shopping list. The system may also rearrange promotional items and/or high margin items that are already on the consumer's shopping list so that the consumer shops for those items first. This may ensure these items are visited or purchased as the consumer may be in a hurry and may not get to all items on the consumer's shopping list.

In yet other examples, the shopping service 10010 may use the data in store and product information service 10090 to select a particular store from a number of potential stores whose layout allows for the quickest shopping experience (e.g., the store is optimally laid out based on the consumer's list), or the store that provides the lowest price on the sum total of the items in the user's list. Travel time and expenses between the consumer's current location or their home and the store may be factored into the cost calculation. For example, if one store has a particular item for a fairly cheap price, but is far away, the cost of going to that store may be higher than just paying the higher price at a more convenient store.

In yet additional examples, the system may break the list into multiple stores based on potential savings. For example, if a first store has item A cheaper than a second store, and the second store has item B cheaper than the first store, the system may inform the user to purchase item A at the first store and item B at the second store. This analysis may factor in travel time and expense to produce a list directing the consumer to purchase the items on their list in such a way as to minimize costs (including travel time and expense). Travel costs and expenses may be based upon a number of factors including distance, gas, gas mileage of the consumer's vehicle, mass transit (e.g., bus) costs, or the like.

In yet other examples, the shopping system may allow users to have goods directly shipped to a particular location, such as their house. For example, the system may interface with an internet commerce service such as internet commerce service 10100. Internet commerce service may allow users to buy their items on-line and have them delivered. For example, Coborns™ Delivers.com, eBay™, Amazon.com™, or the like. In other examples internet commerce system 10100 may include a crowdsourcing application such as TaskRabbit. TaskRabbit allows you to post a task you need to perform (e.g., pickup the items on my shopping list at a store) and the price you are willing to pay. Various individuals bid on these tasks and the winner is assigned to run the task. Once the task is complete the person who completed the task is paid. Thus the shopping system may automatically interface with TaskRabbit to allow users to post their item lists to TaskRabbit along with the price they are willing to pay. The winning bidder on TaskRabbit then shops for the items. Payment and delivery may also be facilitated by the shopping system.

In some examples, the shopping system may be linked to an online payment transaction service such as Paypal™ which may coordinate automatic payment for the items. For example, a user may submit his or her list to a merchant such as Walmart™, Target™, Cub Foods™, or the like and the payment transaction service may process payment for the items. The user then either arranges shipping for the items, or goes to the store to pick up the items. The items may be pre-selected and pulled from the shelves ahead of time by store employees (wherein the user just has to pickup the items), or the items may need to be pulled by the customer.

As already noted, in some examples consumers may choose to link their shopping lists together. As such, a new form of shopping, “social shopping,” may be created. In these examples, one consumer may do the shopping for multiple consumers. The system may facilitate this interaction by allowing consumers who already have pre-existing relationships (e.g., family, or friends) to share their shopping lists with each other. In other examples, the system may facilitate the sharing of shopping lists between consumers with no pre-existing relationships. The system may present users with other consumers who live nearby, share common shopping items and/or interests, or the like. The system may further facilitate social shopping by processing payment for items purchased on behalf of another consumer on the site. In some examples, this may be done through the payment transaction service.

In yet other examples, where the system breaks a consumer's list into multiple stores based on cheapest price, the system may assign each consumer in a group of consumers a particular store or stores, thus eliminating or minimizing the costs of buying multiple items in a list from multiple stores. Thus if consumer A has items A and B on their list, and A is cheapest at store 1 and B is cheapest at store 2 and consumer B has items C and D and C is cheapest at store 1 and D is cheapest at store 2, consumer A would be assigned to shop at store 1 for items A and C and consumer B would be assigned to shop at store 2 for items B and D. The system may then also facilitate payment for the items between the parties and assist in setting up delivery between the parties.

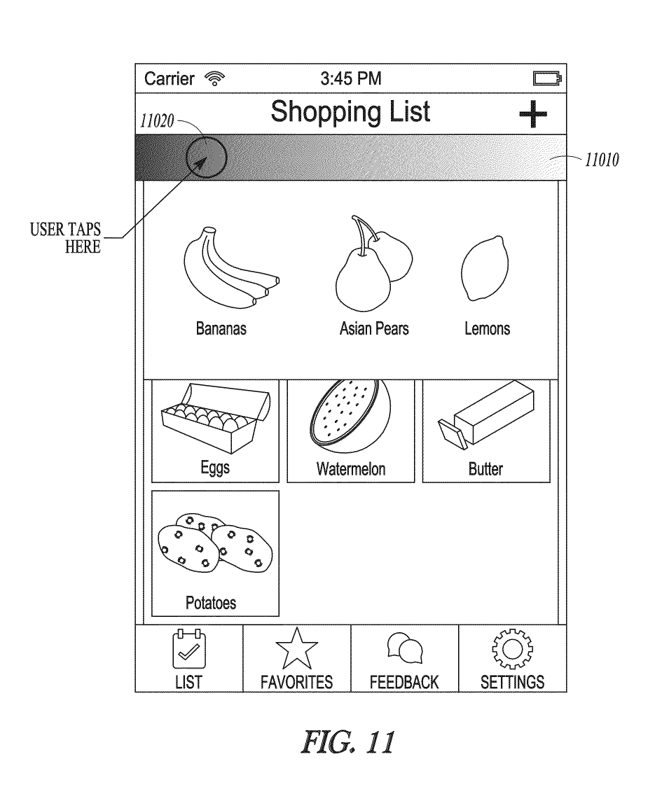

While the above examples described item searching based on name or bar code, in other examples, the items may be selectable by color. FIG. 11 shows one example screen 11000 allowing selection of items based on color. A hue bar 11010 may be displayed with a tappable or dragable point 11020. The hue bar shows colors across the spectrum from red on the left changing to blue and purple on the right. Items matching the hue currently selected by the drag-able point will appear in the suggestions box 11030. This method of selection may be effective for the selection of grocery items, and in particular produce items, as produce items typically have well defined color which can easily be recognized by machine.

In some examples, the system may allow for selection of products by hue by preprocessing the product images to identify the hues that correspond to that product. For each product image the system may attempt to determine a predominant color in the image. This may involve pre-cropping the image, searching for the “interest rectangle” within the image, or the like. The system may then create a color histogram for the cropped area. If a predominant color band is found, extract the hue (often represented as a number from 0-360 degrees), and store that number in a database referencing the product. In some cases, not all products will have a predominant hue. In some examples, the database may be indexed via hue to allow fast access. When the application needs a set of products for a given hue the system may query the database for products with a hue in a range surrounding the hue specified by the user. For instance, if the user chooses the color yellow in the UI (hue value of approximately 60), the system might look for products with a value in the hue column between 50 and 70 and return those products to the client. The “fuzziness” (that is, the width of the range of hues that are considered a match) might be decided on the server side, or might be a user preference.

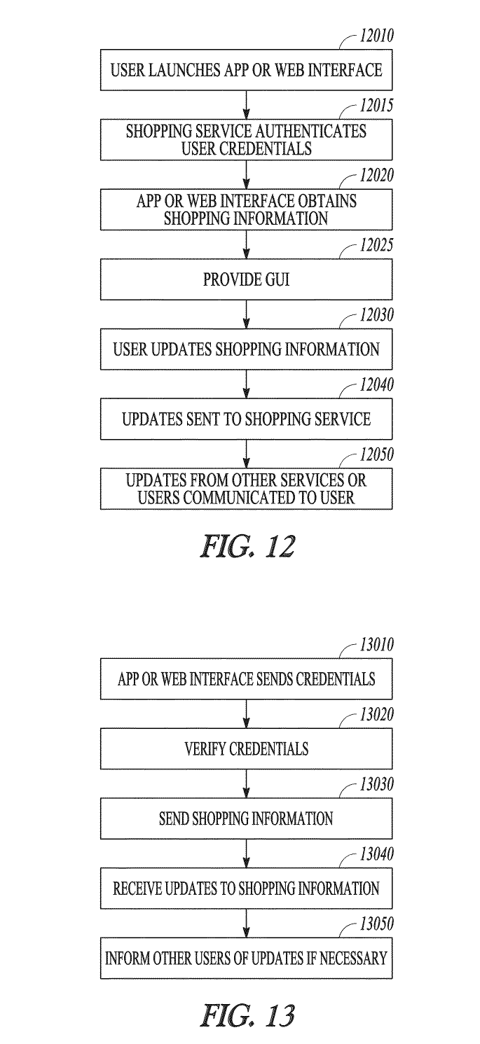

FIG. 12 shows a flowchart of an example method according to some examples of the present disclosure. At operation 12010 the user launches the application their mobile device or other computing device or launches the web interface (e.g., by launching a web browser and directing the browser to the Universal Resource Locator (URL) of the shopping service's web interface). The app or web interface may authenticate with the shopping service using the user's credentials at operation 12015. Once authenticated, the shopping service may send the shopping information to the user's computing device at operation 12020. The shopping information may include the user's shopping lists, product information, custom product information, usage history, favorites, or the like. At operation 12025, once this information is obtained, the application or web-interface may provide the user with one or more graphical user interface menus or displays to enable users to perform the functionality associated with the shopping system. Example displays allow the users to mark items as purchased, add items, add items to favorites, see purchase history, update settings, and the like.

If the user updates any portion of the shopping information at operation 12030, this change may be communicated to the shopping service at operation 12040. This communication may be instantaneous, or the application or web interface may wait and communicate a batch of changes all at once.

If other users are making changes to the shopping information of this account (e.g., the other users are signed in from another computing device), any changes made by that user may be pushed by the shopping service to the user's computing device at operation 12050—allowing the user to see the changes in real time (or near real time). In other examples, the application or web interface may periodically poll the shopping service for any changes in the shopping information.

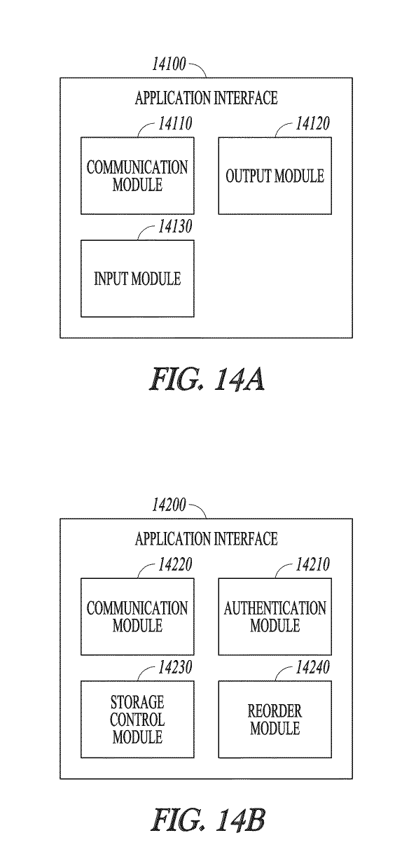

FIG. 13 shows one example flowchart of a method of providing a shopping service according to some examples of the present disclosure. At operation 13010 the service receives credentials from one or more applications or web interfaces. In some examples, the shopping service provides the one or more web interfaces. At operation 13020 the credentials are matched to a user's account and verified. At operation 13030, the shopping information is located in the database and sent to the application or web interface. At operation 13040, any updates made through the web interface or the application are received by the shopping service and saved in the database. The shopping service may maintain a list of active connections (e.g., user's or applications with that account information opened). The shopping service may then inform other users of updates if necessary at operation 13050. Any device with an application connection open may receive a notification that shopping information has changed. For example, while a user is shopping, someone with access to their account might add items. The shopping user may then see these added items and be able to purchase them. In some examples, the web interface or application may de-register with the shopping service once the application or web-interface closes and thus prevent spurious update messages.

In some examples, the notifications of updates to the list may be done even if the application or web interface is not presently executing on the mobile device. For example, mobile devices allow notifications to applications that are not currently executing.

The present application may use the term “service” to denote an electronic service which provides information to a client utilizing the service. The service may include any number of physical servers, databases, and other computing devices. The physical components of the service may be local to each other, or may be distributed across a wide area network (such as the Internet).

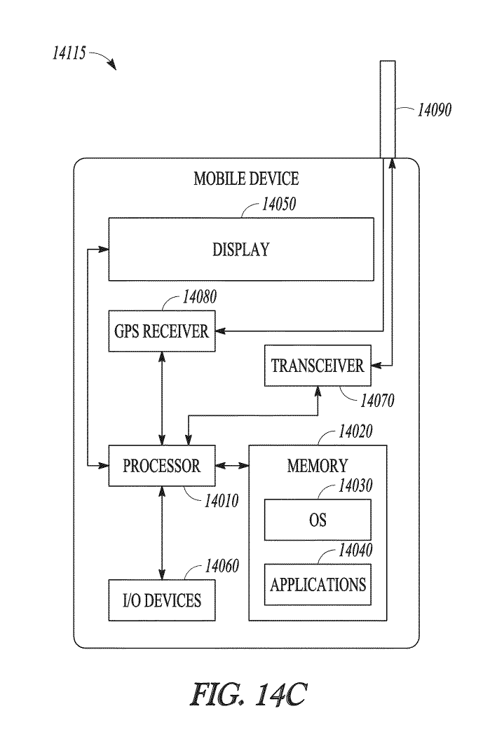

FIG. 14A is a logical block diagram of an example application interface 14100 (either a web-based interface, or a specific application). Communication module 14110 may communicate with the shopping service over a network and may be configured to authenticate with a shopping service over a network using a network adapter. Communication module 14110 may download the shopping list from the shopping service over the network. In the examples in which the web interface is being utilized, communication module 14110 may download one or more web-pages from the shopping service. The communication module 14110 may also send changes to the list, or other user input to the shopping service. Output module 14120 may display a graphical user interface to the user on the display which may display any of the information captured and shown in FIGS. 1-9 and in the case of the web-based interface, the downloaded web pages. For example, the output module 14120 may cause the shopping list to be displayed. In some examples, the shopping list may be displayed as a name of an item, and in other examples, with a graphical representation of an item. In some examples, each item in the shopping list may be displayed as a tile, wherein each tile is arranged in a series of rows and columns. Input module 14130 may receive an input identifying one or more changes to the shopping list from the consumer, input relating to item searches, input related to indicating that the item has been purchased or placed into the consumer's cart.

FIG. 14B is a logical block diagram of an example shopping service 14200, such as shopping service 10010 of FIG. 10. Shopping service may have an authentication module 14210 which authenticates consumers and associates their credentials with their user accounts on the shopping service. Authentication module may also set up new user accounts. Communications module 14220 may communicate with consumer applications and may provide the web-based interface. Communications module 14220 may send a shopping list associated with the consumer's account to the consumer, receive and process changes to the shopping list, receive history information, receive favorite information, or any other information. These changes may be stored by storage control module 14230 which may utilize database(s) such as database 10040 of FIG. 10. In some examples, reordering module 14240 may reorder the shopping list based on various criteria previously described (e.g., store layout, preferred ordering, or the like). Communications module 14220 may also communicate with and process the communications from other components of the shopping system as described in FIG. 10 (e.g., the store and product information service 10090).

FIG. 14C is a block diagram illustrating a mobile device 14115, according to an example embodiment upon which various embodiments may execute. The mobile device 14115 may include a processor 14010. The processor 14010 may be any of a variety of different types of commercially available processors suitable for mobile devices (for example, an XScale architecture microprocessor, a Microprocessor without Interlocked Pipeline Stages (MIPS) architecture processor, a processor operating according to a Reduced Instruction Set (RISC) such as a PowerPC processor, a processor operating according to a Complex Instruction Set (CISC) such as an Intel x086 processor, or another type of processor). A memory 14020, such as a Random Access Memory (RAM), a Flash memory, or other type of memory, may be communicatively coupled to the processor (e.g., through a bus or other communication pipeline). The memory 14020 may be adapted to store an operating system (OS) 14030, as well as application programs 14040, such as an application which allows users to create final product images according to the present disclosure. Example OS' include the Android OS developed by Google Inc., of Mountain View Calif., iOS developed by Apple of Cupertino, Calif., Windows Mobile developed by Microsoft Corp., of Redmond Wash., or the like. The processor 14010 may be coupled, either directly or via appropriate intermediary hardware, to a display 14050 and to one or more input/output (I/O) devices 14060, such as a keypad, a touch panel sensor, a microphone, and the like. For example, the mobile device 14115 may include multi-touch-screen displays which support input entry through multi-touch gestures. Example multi-touch screen displays include capacitive touch screen displays, resistive touch screen displays, or the like. Similarly, in some embodiments, the processor 14010 may be coupled to a transceiver 14070 that interfaces with an antenna 14090. The transceiver 14070 may be configured to both transmit and receive cellular network signals, wireless data signals, or other types of signals via the antenna 14090, depending on the nature of the mobile device 14115. In this manner, a connection with a communication network may be established. For example, the transceiver may operate in accordance with a 2^{nd} Generation wireless network (e.g., a Global System for Mobile Communications GSM network, a General Packet Radio Service GPRS network), a 3^{rd} Generation wireless network (e.g., a Universal Mobile Telecommunications Network UMTS), a 4^{th} Generation wireless network (e.g., Long Term Evolution LTE, Long Term Evolution-Advanced LTE-A), a network according to an Institute for Electrical and Electronics Engineers IEEE 802.11 family of standards (such as 802.11n) or the like. Further, in some configurations, a Global Positioning System receiver 14080 may also make use of the antenna 14090 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

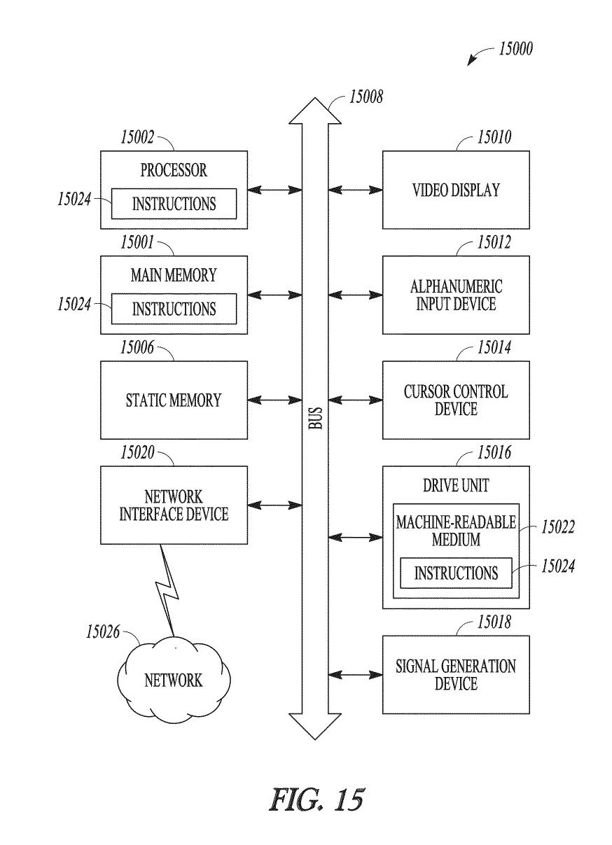

FIG. 15 is a block diagram of machine in the example form of a computer system 15000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. For example, any one of the components of the shopping system and the computing devices for executing the application or web interface may be or include components shown in FIG. 15.

The example computer system 15000 includes a processor 15002 (e.g., a central processing unit (CPU), a graphics processing unit (GPU) or both), a main memory 15004 and a static memory 15006, which communicate with each other via a bus 15008. The computer system 15000 may further include a video display unit 15010 (e.g., a liquid crystal display (LCD) or a cathode ray tube (CRT)). The computer system 15000 also includes an alphanumeric input device 15012 (e.g., a keyboard), a user interface (UI) navigation device 15014 (e.g., a mouse), a disk drive unit 15016, a signal generation device 15018 (e.g., a speaker) and a network interface device 15020.

### Machine-Readable Medium

The disk drive unit 15016 includes a machine-readable medium 15022 on which is stored one or more sets of instructions and data structures (e.g., software) 15024 embodying or used by any one or more of the methodologies or functions described herein. The instructions 15024 may also reside, completely or at least partially, within the main memory 15004, static memory 15006, and/or within the processor 15002 during execution thereof by the computer system 15000, the main memory 15004 and the processor 15002 also constituting machine-readable media.

While the machine-readable medium 15022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 15024 may further be transmitted or received over a communications network 15026 using a transmission medium. The instructions 15024 may be transmitted using the network interface device 15020 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Other Notes

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of providing assistance to a consumer comprising:
authenticating with a shopping service over a network using a network adapter;
downloading a shopping list from the shopping service over the network using the adapter;
displaying the shopping list to the user on a display screen, the shopping list comprising a name of an item, wherein each item in the shopping list is displayed as a tile, wherein each tile is arranged in a series of rows and columns;
receiving an input identifying one or more changes to the shopping list;
processing the input using a computer processor; and
sending the one or more changes to the shopping service over the network using the network adapter.

2. The method of claim 1, wherein the input includes an input to add an item to the shopping list.

3. The method of claim 2, wherein the input includes a text input and wherein the method further comprises outputting to the display a list of suggested items based upon the text as it is being inputted.

4. The method of claim 3, wherein the list of suggested items is ordered based on whether or not the suggested items are included in a list of favorite items.

5. The method of claim 4, wherein the list of suggested items is ordered based on whether or not the suggested items were recently purchased items.

6. The method of claim 2, wherein the input is a hue, and wherein the method further comprises outputting to the display a hue bar and a hue selector and outputting to the display suggested items based upon the currently selected hue.

7. The method of claim 1, wherein receiving the input includes identifying an item as a favorite item.

8. The method of claim 1, wherein receiving the input includes identifying an item as having been purchased.

9. The method of claim 1, wherein the shopping list comprises items that the consumer desires to purchase and one or more items that a second consumer desires to purchase.

10. The method of claim 9, wherein the first and second consumers have a pre-existing social relationship.

11. The method of claim 9, comprising accepting payment from the second consumer for the one or more items in that the second consumer desires to purchase.

12. The method of claim 1, comprising: sending the shopping list to a crowdsourcing application to purchase the items.

13. A method of providing a shopping service comprising:
receiving authentication credentials from a first computing device;
verifying that the authentication credentials match a consumer account;
sending a shopping list of the consumer account to the first computing device;
receiving one or more changes to the shopping list from the first computing device;
storing the one or more changes to the shopping list; and
responsive to determining that there is a second computing device which is logged into the consumer account, sending the one or more changes to the shopping list of the client to the second computing device.

14. The method of claim 13, wherein the one or more changes to the shopping list comprises information on an item which is not in an item database of the shopping service and wherein the method further comprises storing the information on the item in the item database.

15. The method of claim 13, comprising receiving from the first computing device a selection of a store and wherein the method further comprises:
sending a request over a network to a store information service;
receiving a store layout corresponding to the selected store;
reordering the shopping list based on the store layout.

16. The method of claim 15, wherein the shopping list is reordered so that one or more items on the shopping list are arranged such that a consumer purchasing those items in the arranged order would take the most efficient path through the store.

17. The method of claim 15, wherein the shopping list is reordered based upon an order in which the one or more items on the shopping list were marked as purchased in the past.

18. The method of claim 15, wherein the store layout is received from the first computing device and is created by a consumer.

19. The method of claim 15, comprising receiving a preferred walking route through the selected store and wherein the shopping list is reordered so that one or more items on the shopping list are arranged such that a consumer purchasing those items in the arranged order would take the preferred walking route.

20. The method of claim 15, wherein the shopping list is reordered so that one or more items on the shopping list are arranged such that a consumer purchasing those items in the arranged order would walk past one or more promotional items in the store.

21. The method of claim 15, wherein the shopping list is reordered so that one or more items on the shopping list are arranged such that a consumer purchasing those items in the arranged order would walk past one or more high margin items in the store.

22. The method of claim 13, further comprising receiving an indication from the first computing device that an item on the shopping list was purchased and storing the indication as a purchase history.

23. The method of claim 13, wherein the first computing device is a mobile computing device.

24. The method of claim 13, wherein the second computing device utilizes a web based interface.

25. A system of providing assistance to a consumer comprising:
a communication module configured to:
authenticate with a shopping service over a network using a network adapter;
download a shopping list from the shopping service over the network using the adapter;
an output module configured to:
display the shopping list to the user on a display screen, the shopping list comprising a name of an item, wherein each item in the shopping list is displayed as a tile, wherein each tile is arranged in a series of rows and columns;
an input module configured to:
receive an input identifying one or more changes to the shopping list;
process the input; and
wherein the communication module is configured to send the one or more changes to the shopping service over the network using the network adapter.

26. The system of claim 25, wherein the input includes an input to add an item to the shopping list.

27. The system of claim 26, wherein the input includes a text input and wherein the output module is further configured to output to the display a list of suggested items based upon the text as it is being inputted.

28. The system of claim 27, wherein the list of suggested items is ordered based on whether or not the suggested items are included in a list of favorite items.

29. The system of claim 28, wherein the list of suggested items is ordered based on whether or not the suggested items were recently purchased items.

30. The system of claim 26, wherein the input is a hue, and wherein the output module is further configured to output to the display a hue bar and a hue selector and output to the display suggested items based upon the currently selected hue.

31. The system of claim 25, wherein receiving the input includes identifying an item as a favorite item.

32. The system of claim 26, wherein receiving the input includes identifying an item as having been purchased.

33. The system of claim 26, wherein the shopping list comprises items that the consumer desires to purchase and one or more items that a second consumer desires to purchase.

34. A shopping service comprising:
an authentication module configured to:
receive authentication credentials from a first computing device;
verify that the authentication credentials match a consumer account;
a communications module configured to:
send a shopping list of the consumer account to the first computing device;
receive one or more changes to the shopping list from the first computing device;
a storage module configured to:
store the one or more changes to the shopping list; and
responsive to determining that there is a second computing device which is logged into the consumer account, the communications module is configured to send the one or more changes to the shopping list of the client to the second computing device.

35. The system of claim 34, wherein the one or more changes to the shopping list comprises information on an item which is not in an item database of the shopping service and wherein the method further comprises storing the information on the item in the item database.

36. The system of claim 34, wherein the communication module is configured to:
receive from the first computing device a selection of a store;
send a request over a network to a store information service;
receive a store layout corresponding to the selected store; and
wherein the system comprises a reordering module configured to reorder the shopping list based on the store layout.

37. The system of claim 36, wherein the reorder module is configured to reorder the shopping list so that one or more items on the shopping list are arranged such that a consumer purchasing those items in the arranged order would take the most efficient path through the store.

38. The method of claim 36, wherein the reorder module is configured to reorder the shopping list based upon an order in which the one or more items on the shopping list were marked as purchased in the past.

39. The system of claim 36, wherein the communications module is configured to receive a preferred walking route through the selected store and wherein the reorder module is configured to reorder the shopping list so that one or more items on the shopping list are arranged such that a consumer purchasing those items in the arranged order would take the preferred walking route.

40. The system of claim 34, wherein the communications module is configured to receive an indication from the first computing device that an item on the shopping list was purchased and the storage module is configured to store the indication as a purchase history.

41. A machine readable medium, comprising instructions, which when performed by the machine, cause the machine to perform the operations of:
authenticating with a shopping service over a network using a network adapter;
downloading a shopping list from the shopping service over the network using the adapter;
displaying the shopping list to the user on a display screen, the shopping list comprising a name of an item, wherein each item in the shopping list is displayed as a tile, wherein each tile is arranged in a series of rows and columns;
receiving an input identifying one or more changes to the shopping list;
processing the input using a computer processor; and
sending the one or more changes to the shopping service over the network using the network adapter.

42. A machine readable medium, comprising instructions, which when performed by the machine, cause the machine to perform the operations of:
receiving authentication credentials from a first computing device;
verifying that the authentication credentials match a consumer account;
sending a shopping list of the consumer account to the first computing device;
receiving one or more changes to the shopping list from the first computing device;
storing the one or more changes to the shopping list; and
responsive to determining that there is a second computing device which is logged into the consumer account, sending the one or more changes to the shopping list of the client to the second computing device.
